(19) United States
(12) Patent Application Publication
(10) Pub. No.: US 2015/0163710 A1
(43) Pub. Date: Jun. 11, 2015

(54) METHODS AND APPARATUS FOR EVENT REPORTING BASED SPURIOUS DPCH REMOVAL IN SOFT HANDOVER

(71) Applicant: QUALCOMM Incorporated, San Diego, CA (US)

(72) Inventors: Wei ZHANG, Santa Clara, CA (US); Nate Chizgi, Sunnyvale, CA (US); Sagar Bharatkumar Shah, San Diego, CA (US); Rami Hmeidan Alnatsheh, San Diego, CA (US); Sharif Ahsanul Matin, San Diego, CA (US); Vijay Marwah, San Diego, CA (US)

(73) Assignee: QUALCOMM Incorporated, San Diego, CA (US)

(21) Appl. No.: 14/285,381

(22) Filed: May 22, 2014

Related U.S. Application Data
(60) Provisional application No. 61/912,925, filed on Dec. 6, 2013.

(51) Int. Cl. H04W 36/00; H04W 36/18

(52) U.S. Cl. CPC H04W 36/0083; H04W 36/18

(57) ABSTRACT

Methods and apparatus for event reporting based spurious dedicated physical channel (DPCH) removal in soft handover include user equipment (UE) management of spurious channels. In one aspect, the disclosure provides methods and apparatus for wireless communication that may include determining that a dedicated physical channel (DPCH) is spurious, removing the DPCH from soft combining, and sending a report indicating that a cell associated with the DPCH is unavailable. Further, the methods and apparatus may include incrementing a counter for the cell associated with the DPCH in response to removing the DPCH, determining whether the counter exceeds a removal threshold, and increasing a time to trigger for sending a report to add the cell to an active set in response to the counter exceeding the removal threshold. A cell associated with a removed DPCH may also be excluded from measurements of a current frequency.

### CLAIM OF PRIORITY UNDER 35 U.S.C. §119

The present application for patent claims priority to Provisional Application No. 61/912,925 entitled “EVENT REPORTING BASED SPURIOUS DPCH REMOVAL IN SOFT HANDOVER” filed Dec. 6, 2013 and assigned to the assignee hereof and hereby expressly incorporated by reference herein.

### BACKGROUND

Aspects of the present disclosure relate generally to wireless communication systems, and more particularly, to radio access networks.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In a soft handover scenario, a wireless device may communicate with multiple base stations. Occasionally, when a new base station is added to the active set communicating with the wireless device, the signal quality of a combined dedicated physical channel may deteriorate. The poor quality may be due to a spurious dedicated physical channel.

### SUMMARY

Methods and apparatus for event reporting based spurious dedicated physical channel (DPCH) removal in soft handover include user equipment (UE) management of spurious channels. In one aspect, the disclosure provides methods and apparatus for wireless communication that may include determining that a dedicated physical channel (DPCH) is spurious, removing the DPCH from soft combining, and sending a report indicating that a cell associated with the DPCH is unavailable. Further, the methods and apparatus may include incrementing a counter for the cell associated with the DPCH in response to removing the DPCH, determining whether the counter exceeds a removal threshold, and increasing a time-to-trigger for sending a report to add the cell to an active set in response to the counter exceeding the removal threshold. A cell associated with a removed DPCH may also be excluded from measurements of a current frequency.

In an aspect, the present disclosure provides a method for wireless communication. The method includes determining that a DPCH is spurious. The method further includes removing the DPCH from soft combining. The method also includes sending a report indicating that a cell associated with the DPCH is unavailable.

In another aspect, the present disclosure provides an apparatus for wireless communication. The apparatus includes means for determining that a DPCH is spurious. The apparatus further includes means for removing the DPCH from soft combining. The apparatus also includes means for sending a report indicating that a cell associated with the DPCH is unavailable.

Yet another aspect of the present disclosure provides a computer program product having a non-transitory computer-readable medium. The non-transitory computer-readable medium includes code for causing a computer to determine that a DPCH is spurious, code for causing the computer to remove the DPCH from soft combining, and code for causing the computer to send a report indicating that a cell associated with the DPCH is unavailable.

In another aspect, the present disclosure provides an apparatus for wireless communication including at least one processor and a memory coupled to the at least one processor. The at least one processor is configured to determine that a DPCH is spurious, remove the DPCH from soft combining, and send a report indicating that a cell associated with the DPCH is unavailable.

These and other aspects of the invention will become more fully understood upon a review of the detailed description, which follows.

### BRIEF DESCRIPTION OF THE DRAWINGS

FIG. 1 is a schematic diagram conceptually illustrating a communication network including an aspect of a user equipment that may perform management of spurious channels.

FIG. 2 is a flowchart conceptually illustrating an aspect of a method of wireless communication, e.g., according to FIG. 1.

FIG. 3 is a flowchart conceptually illustrating another aspect of a method of wireless communication.

FIG. 4 is a block diagram conceptually illustrating an example of a hardware implementation for an apparatus employing a processing system.

FIG. 5 is a block diagram conceptually illustrating an example of a telecommunications system.

FIG. 6 is a conceptual diagram illustrating an example of an access network.

FIG. 7 is a conceptual diagram illustrating an example of a radio protocol architecture for the user and control plane.

FIG. 8 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In a wireless network, a network entity providing a serving cell for a wireless device may communicate with the wireless device using a variety of channels for various purposes. Generally, a common pilot channel (CPICH) is broadcast by the serving cell to identify the cell. A wireless device generally measures the CPICH to determine the quality of the serving cell. A dedicated physical channel (DPCH) may be assigned to a wireless device for carrying user data. In a soft handover, a wireless device may receive a DPCH from multiple cells and the signals may be combined.

A spurious DPCH may occur when, for various reasons, the quality of a DPCH is less than expected. For example, a spurious DPCH may have lower quality than the quality of the CPICH from the same cell because of interference that affects only the DPCH. A spurious DPCH may contribute negatively to soft combining as the low quality signal may reduce the ability to accurately combine the DPCH from different cells. In conventional systems, the spurious DPCH may not be identified and may remain part of the active set for soft combining despite the negative impact. In an aspect, the present disclosure provides for identification and removal of a spurious DPCH to improve the performance of soft combining.

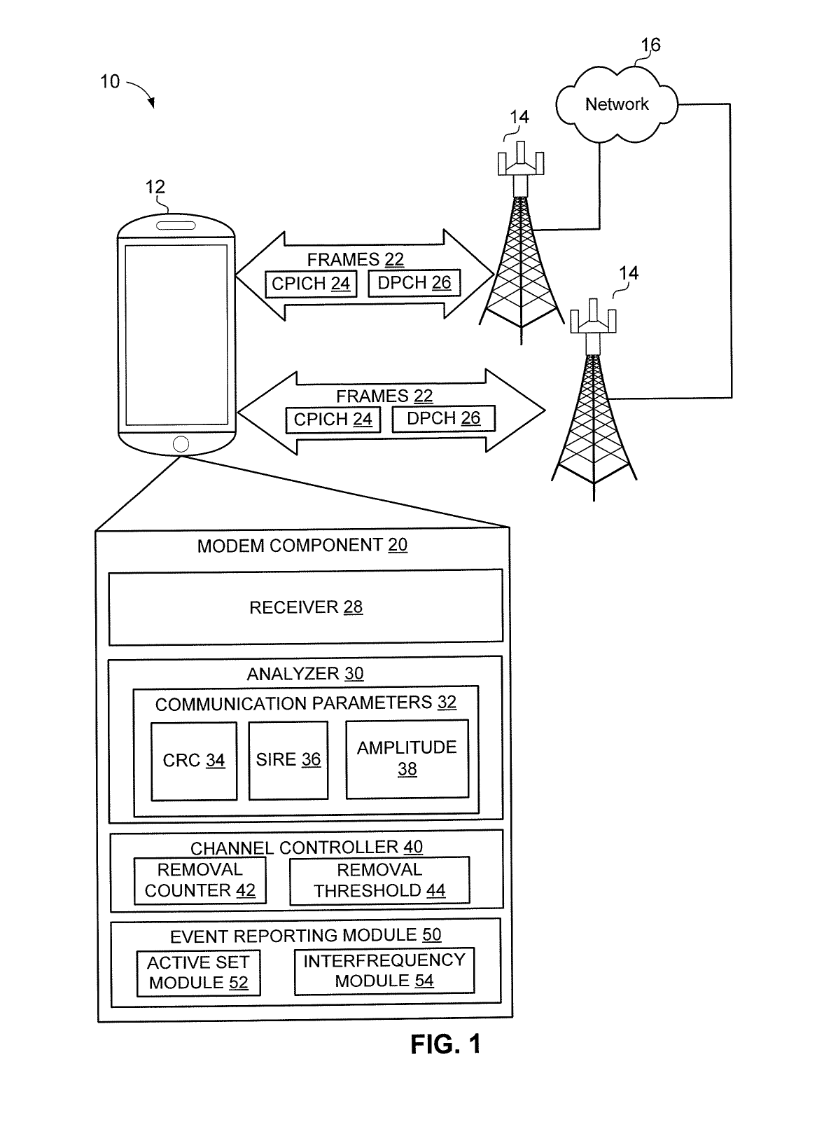

Referring to FIG. 1, in an aspect, a wireless communication system 10 includes at least one UE 12 in communication coverage of at least one network entity 14 (e.g., base station). UE 12 may communicate with network 16 via network entity 14. In some aspects, multiple UEs including UE 12 may be in communication coverage with one or more network entities, including network entity 14. In an example, UE 12 may transmit and/or receive wireless communications 18 to and/or from network entity 14. Such wireless communications 18 may include, but are not limited to, one or more frames 22 that may include, or be used to obtain, one or more communication parameters 32 of channels used to carry the frames 22. In such cases, UE 12 may receive one or more frames 22 from network entity 14, which may also be considered the serving cell for UE 12. In a soft handover state, UE 12 may be in communication with multiple network entities 14 in an active set. Each network entity 14 may communicate using a primary scrambling code (PSC) and one or more channels, for example, a common pilot channel (CPICH) 24 and a dedicated physical channel (DPCH) 26. The DPCH channel information received from multiple network entities 14 may be combined using soft combining to provide improved signal quality. Various soft combining techniques may be used, for example, equal-gain combining, maximal-ratio combining, switched combining, or selection combining. In such aspects, one or more components and/or subcomponents of UE 12 (e.g., modem component 20), may operate to control the channels and network entities 14 used by UE 12.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. Additionally, network entity 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

According to the present aspects, UE 12 may include modem component 20, which may be configured to detect and remove spurious channels. For example, in a soft handover state, modem component 20 may receive at least one frame 22 from a plurality of network entities 14 and determine (e.g., decode) one or more channels such as CPICH 24 or DPCH 26. A frame 22 may include additional channels (not shown). The present aspects provide a UE side approach to channel management permitting modem component 20 to evaluate and remove a spurious DPCH. As used herein, the term “spurious channel” may refer to any channel that has a lower quality than expected. For example, a spurious channel may be incorrect, improper, corrupted, inaccurate, blocked, interfered with, or otherwise defective in some way. In another example, a spurious DPCH may be contributing negatively to soft combining. Contributing negatively may refer to reducing the overall signal quality when performing soft combining or other signal processing. Contributing positively may refer to improving or increasing the overall signal quality when performing soft combining or other signal processing. Removal of a spurious DPCH may include, rather than decoding a signal based on all cells in an active set, modem component 20, and/or one or more subcomponents thereof, may remove a particular DPCH 26 from soft combining to improve signal quality. Moreover, the modem component 20 may send an event report to have the spurious DPCH removed from the active set by the network.

Specifically, modem component 20 may include a receiver 28 configured to receive at least one frame 22 from a network entity (e.g., network entity 14). The frame 22 may be associated with one or more channels such as CPICH 24 and DPCH 26. The receiver 28 may demodulate and descramble a signal received on an antenna to derive CPICH 24 and DPCH 26. A CPICH 24 and DPCH 26 may be associated with each network entity 14. The receiver 28 may also perform measurements on the received signal and provide such measurements to the analyzer 30.

Modem component 20 may further include an analyzer 30 configured to determine whether a channel such as DPCH 26 is spurious. Analyzer 30 may determine one or more communication parameters 32 based on the one or more frames 22. For example, communication parameters 32 may be configured to, or provide modem component 20 the ability to analyze the quality of the DPCH. That is, using the communication parameters 32 received as part of, included within, or derived from frames 22, analyzer 30 may determine whether a DPCH is spurious.

In some aspects, one or more communication parameters 32 may be mapped to, part of, or relevant to specific subcomponents of modem component 20. One or more communication parameters 32 may include, but not be limited to, cyclic redundancy check (CRC) error rate 32, signal-to-interference ratio estimate (SIRE) 34, and channel power amplitude 38. For example, one or more of the foregoing communication parameters 32 may be based on signal measurements provided by receiver 28. The communication parameters 32 may also include quality measurements determined by analyzer 30, for example, after decoding the received signals. Analyzer 30 may be configured to use the communication parameters 32 to determine whether a DPCH is spurious. Modem component 20 or analyzer 30 may further include additional subcomponents or otherwise be configured to provide other quality measurements. It should be apparent that quality measurements may be compared with other communication parameters 32 or otherwise combined to provide other quality measurements.

In an aspect, analyzer 30 may be configured to compare or otherwise analyze one or more communication parameters 32 for a DPCH with respect to the other DPCH in the active set. That is, analyzer 30 may be configured to apply one or more formulas or thresholds applicable to communication parameters 32 for determining whether a DPCH is spurious. As a non-limiting example, CRC 34, SIRE 36, and amplitude 38 may be determined for a channel from frames 22. Analyzer 30 may be configured to apply the determined communication parameters 32 to various criteria to determine whether a DPCH 26 is spurious. For example, DPCH 26 may be spurious if a power amplitude of CPICH 24 is greater than a threshold while a power amplitude of DPCH 26 is less than a threshold. As another example, the SIRE 36 of one DPCH 26 may be compared to the SIRE 36 of another DPCH 26. As yet another example, the contribution of a DPCH 26 in soft combining may be determined by generating a hypothetical decoding without a particular DPCH. If the hypothetical decoding has an improved SIRE 36 or CRC 34, the DPCH 26 may be considered spurious.

Modem component 20 may further include a channel controller 40 configured to remove a DPCH that has been determined to be spurious from soft combining, so that the spurious DPCH has no effect on decoding. Although the UE 12 may receive signals from a network entity 14 associated with the spurious DPCH, channel controller 40 may block or otherwise exclude the signal from the network entity 14 from soft combining. For example, channel controller 40 may prevent decoding of a signal using a primary scrambling code (PSC) associated with a DPCH 26 and network entity 14. Accordingly, the removed DPCH will have no effect on the soft combining. It should be understood that such analysis and removal of DPCH by modem component 20 may occur on the downlink.

Channel controller 40 may further include a removal counter 42 for tracking the number of times that a DPCH associated with a network entity 14 has been removed. Repeated removal of a spurious DPCH associated with a network entity 14 may indicate that the network entity 14 is problematic. The channel controller 40 may further include a removal threshold 44 indicating a limit on the number of times that a DPCH is removed before the channel controller 40 performs further action. As an example, the removal threshold 44 may be configured with a value between approximately 3 and approximately 10, inclusive. Once the removal counter 42 exceeds the removal threshold 44, the channel controller 40 may attempt to prevent the network entity 14 from creating a new spurious DPCH. For example, the channel controller 44 may delay or forbid addition of the network entity 14 to the active set.

Modem component 20 may also include an event reporting module 50 configured to manage spurious channels through event reporting. When a DPCH has been removed, the event reporting module 50 may then send an event report indicating that the network entity providing the DPCH is no longer in range. For example, event reporting module 50 may include an active set module 52 for reporting on the active set of network entities 14 and an interfrequency module 54 for reporting on different frequencies. The event reporting module 50 may generate and send event reports, such as those defined in 3GPP TS 25.331.

In an aspect, active set module 52 may send an E1A report indicating that the network entity 14 associated with a DPCH 26 is unavailable when the DPCH 26 is determined to be spurious. Although the UE 12 has received a signal from the network entity 14, the active set module 52 may report the network entity 14 as unavailable in order to force an action by the network. For example, the network 16 may send an active set update (ASU) command removing the network entity 14, or may reconfigure the network entity 14. Active set module 52 may also send an E2A report indicating that a network entity 14 has become available. In an aspect, the active set module 52 may delay sending the E2A report for a network entity 14 that has previously provided a spurious DPCH. The delay may allow the modem component 20 to determine whether the signal provided by network entity 14 is a sufficient quality. Active set module 52 may also forbid the E2A message to prevent adding a spurious DPCH to the active set.

Interfrequency module 54 may send event reports regarding a frequency currently used by the UE 12 in comparison to other frequencies. When the modem component 20 removes a spurious DPCH from soft combining, interfrequency module 54 may also remove the spurious DPCH from frequency based measurements. Otherwise, the interfrequency module 54 might report an incorrect comparative quality measurement of the current frequency due to the spurious DPCH. Instead, interfrequency module 54 may exclude the spurious DPCH from the comparison with other frequencies. Interfrequency module 54 may send event reports such as E2A, E2B and E2D indicating a current status of the frequency in relation to other frequencies.

In additional aspects, modem component 20 may be configured to transmit and receive wireless communication on the one or more communication channels 18 using one or more radio access technologies (RATs) with one or more network entities (e.g., network entity 14). For example, in an aspect, the modem component 20 may receive one or more frames 22 from one or more network entities (e.g., network entity 14). Further, modem component 20 may include, but is not limited to, one or more of a transmitter, a receiver, a transceiver, protocol stacks, transmit chain components, and receive chain components.

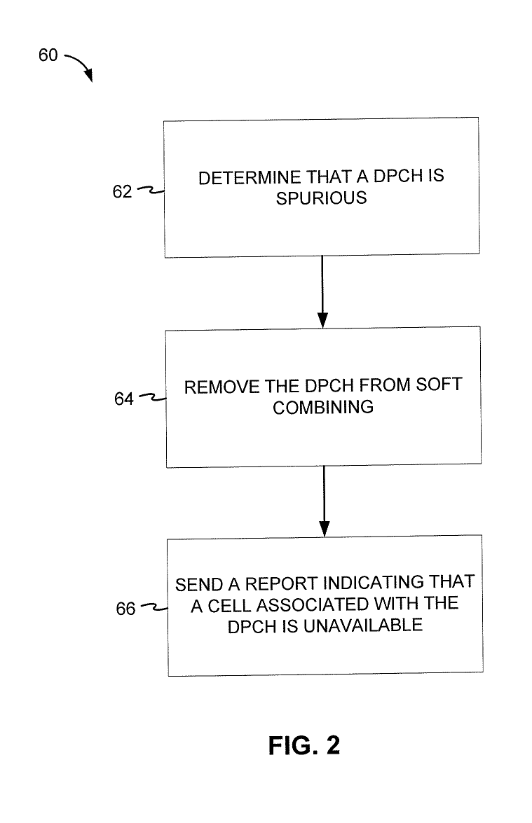

Referring to FIG. 2, in an operational aspect, a UE such as UE 12 (FIG. 1) may perform one aspect of a method 60 of wireless communication. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 62, the method 60 may include determining that a DPCH is spurious. The analyzer 30 (FIG. 1) may determine that the DPCH is spurious. In an aspect, the analyzer 30 may determine that the DPCH is spurious when a quality measurement of a CPICH of the cell is greater than a quality threshold and a quality measurement of the DPCH for the cell is less than a quality threshold. In another aspect, the analyzer 30 may determine that the DPCH is spurious by determining a ratio of a quality measurement of a CPICH of the cell to a quality measurement of the DPCH of the cell. In another aspect, the analyzer 30 may determine that the DPCH is spurious by determining that a quality of the DPCH for the cell is less than the quality of a DPCH for a plurality of other cells in an active set. In another aspect, determining that a DPCH is spurious includes determining that the DPCH contributes negatively to soft combining.

In an aspect, at block 64, the method 60 may include removing the DPCH from soft combining. The receiver 28 (FIG. 1) may remove the DPCH from soft combining. The receiver 28 may remove the spurious DPCH from soft combining by excluding the received signal including the spurious DPCH from the combination of DPCH. For example, the receiver 28 may block or prevent decoding using a PSC associated with the spurious DPCH.

In an aspect, at block 66, the method 60 may include sending a report indicating that a cell associated with the DPCH is unavailable. The event reporting module 50 (FIG. 1) may send the report indicating that the cell associated with the DPCH is unavailable. The report may be, for example, an E1B report indicating that a signal strength of the cell has fallen below a threshold. The event reporting module 50 may send the report indicating that the cell associated with the DPCH is unavailable despite receiving a CPICH for the cell satisfying a quality threshold, for example a signal strength exceeding the threshold. In other words, the event reporting module 50 may force the report even through a condition, defined by a standard, for sending the report is not true. In another aspect, the event reporting module 50 may define new criteria for sending the event report based on the quality of the DPCH rather than the CPICH.

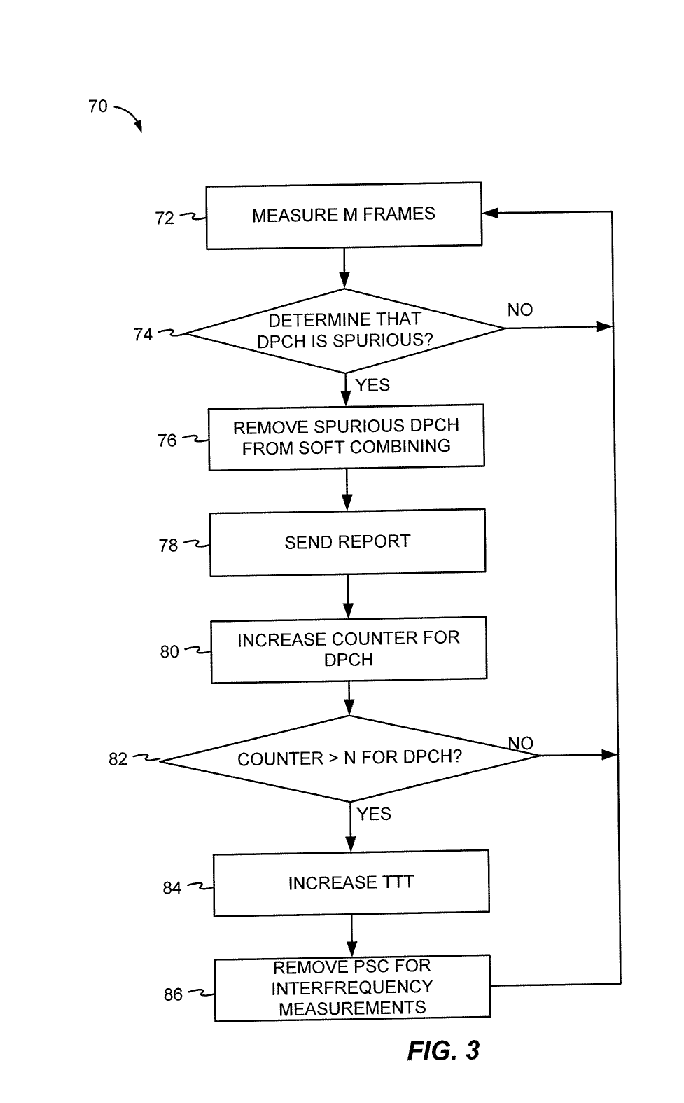

Referring to FIG. 3, in an operational aspect, a UE such as UE 12 (FIG. 1) may perform one aspect of a method 70 for channel management. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 72, method 70 includes measuring the communication parameters of channels over several frames. For example, as described herein, UE 12 (FIG. 1) may execute modem component 20 or receiver 28 to receive at least one frame (e.g., frames 22) from a network entity (e.g., network entity 14). The UE 12 may determine one or more communication parameters. For instance, as described herein, UE 12 (FIG. 1) may execute analyzer 30 to determine one or more communication parameters (e.g., communication parameters 32) based on the at least one frame. In some aspects, the UE 12 may determine communication parameters over a number of frames, for example, 4 frames or 10 frames. In some aspects, the one or more communication parameters comprise channel quality measurements such as a signal-to-interference ratio estimate (SIRE) 36, and a cyclic redundancy check (CRC) error rate 34. The UE 12 may determine one or more channel quality measurements for a CPICH and a DPCH for one or more cells. The analyzer 30 may separately determine quality measurements for the CPICH and the DPCH for each cell. The analyzer 30 may also determine a quality measurement based on a combined signal for multiple cells. For example, CRC 34 or SIRE 36 may be determined based the combined signal generated by soft combining and/or for each individual signal.

At block 74, method 70 further includes determining whether a DPCH is spurious. Analyzer 30 may analyze the determined communication parameters 32 to determine whether a DPCH is spurious. A spurious DPCH may be any DPCH that has lower quality than expected. For example, a CPICH may indicate a strong, high-quality signal associated with a PSC or cell, but the quality measurements of the DPCH associated with the PSC or cell may be poor. In a soft handover scenario, the poor quality DPCH may contribute negatively to soft combining and the UE's decoding performance. The spurious DPCH may cause the CRC error ratio of the combined DPCH to increase and the SIRE of the combined DPCH to decrease. A low measured SIRE value for the combined DPCH may lead the UE to determine that is out of sync even though at least one of the cells is providing a strong DPCH.

In various aspects, the determining that a DPCH is spurious includes determining that a quality measurement of a CPICH of the cell is greater than a quality threshold and a quality measurement of a DPCH for the cell is less than a quality threshold. Similarly, the ratio of the quality measurement of the CPICH and the DPCH may indicate a spurious DPCH. A high quality of CPICH to quality of DPCH ratio may indicate that the DPCH is spurious. The ratio of the quality measurements for the CPICH and the DPCH may be compared to a threshold, and the DPCH may be considered spurious if the ratio exceeds the threshold. In another aspect, a spurious DPCH may be detected by determining that a quality of the DPCH for a cell is less than the quality of a DPCH for a plurality of other cells in the active set. In yet another aspect, determining that a DPCH is spurious includes determining that the DPCH does not contribute positively to signal quality of a combined signal. The analyzer 30 may test whether a DPCH is contributing positively or negatively to soft combining by performing soft combining both with and without a potentially spurious DPCH. A communication parameter such as, for example, CRC 34 or SIRE 36 may be determined for the combined signal, both with and without the DPCH. If the combined signal has a worse communication parameter with the DPCH, the analyzer 30 may determine that the DPCH is contributing negatively, and therefore, is a spurious DPCH. If the combined signal has a better communication parameter with the DPCH, the analyzer 30 may determine that the DPCH is contributing positively, and therefore, is not a spurious DPCH.

If no DPCH is detected as spurious, the method 70 may return to block 72 and continue to perform measurements. If a DPCH is detected as spurious, the method 70 may proceed to block 76.

Moreover, at block 76, method 70 includes removing a spurious DPCH from soft combining. The channel controller 40 may cause the modem component 20 to remove the spurious DPCH. The frames 22 received from the network entity 14 including the DPCH may be excluded from the decoding operation. Removal from the decoding operation may immediately prevent any negative effects on the decoding quality, for example, an increased CRC error rate. The DPCH may remain a member of the active set as provided by the network 16.

At block 78, method 70 includes sending an event report indicating that the cell associated with the DPCH has been removed from the active set. The event reporting module 50 may generate and transmit the appropriate event report. The event report, may be, for example, an E1B report as defined by 3GPP TS 25.331. The E1B report may be considered a forced report because the CPICH of the cell may not satisfy a condition for sending the E1B report. For example, the CPICH for the cell may have a strong quality measurement indicating that cell is providing a strong signal even though the DPCH is spurious. After an E1B report is sent, the UE may expect to receive an active set update (ASU) command from the network indicating that the cell associated with the DPCH should be removed from the active set. Various network operators, however, may not send an ASU command based on an E1B report.

At block 80, the method 70 includes incrementing the value of a counter for the DPCH. The channel controller 40 may increment the removal counter 42 (FIG. 1) for a cell or PSC associated with the DPCH. The removal counter 42 may indicate the number of times that the DPCH has been removed as a spurious DPCH, that is, the number of times that the UE sent a forced E1B report. The removal counter 42 may be initialized at the beginning of a call and maintained throughout the call.

At block 82, the method 70 includes determining whether the counter for the removed DPCH exceeds a removal threshold N. The channel controller 40 may compare the removal counter 42 to the configured removal threshold 44. The removal threshold may be configured based a desired confidence that the removed DPCH is presenting a continuing problem. For example, the removal threshold N may have a value between 3 and approximately 10. If the removal counter remains less than the removal threshold, the method 70 may return to block 72, where the measuring may continue. If the removal counter exceeds the removal threshold, the method 70 may proceed to block 84.

At block 84, the method 70 includes increasing a time to trigger (TTT) for sending an event report adding the cell to the active set. For example, the event report may be an E1A report that indicates a new CPICH has been detected. The event reporting module 50 may be configured to send the E1A report when a new CPICH has satisfied criteria such as quality measurements for the length of the ITT. The channel controller 40 may adjust the configured TTT of event reporting module 50 for an E1A report for a specific PSC or call. By increasing the TTT, the UE makes it more difficult for the CPICH to be reported and for the cell to be added to the active set. Accordingly, a cell with a history of providing spurious DPCHs will be less likely to be added to the active set. However, because it is possible for the cell to change the configuration of the DPCH, it is still possible for the cell to be added to the active set when it is providing a high quality signal.

At block 86, the method 70 includes removing the PSC associated with the spurious DPCH from interfrequency measurements. The interfrequency module 54 may exclude the PSC from calculations used for interfrequency measurement and reporting. The interfrequency measurements may be used to determine whether the UE should change frequencies. Removal of the PSC from the interfrequency measurements may provide a more accurate measurement of the current frequency in comparison to other available frequencies. The results of interfrequency measurements may be reported in, for example, an E2A, E2B, or E2D event report. The event reporting module 50 may send an event report based on an interfrequency measurement excluding the spurious DPCH. The method 50 may return to block 52, where measuring may continue.

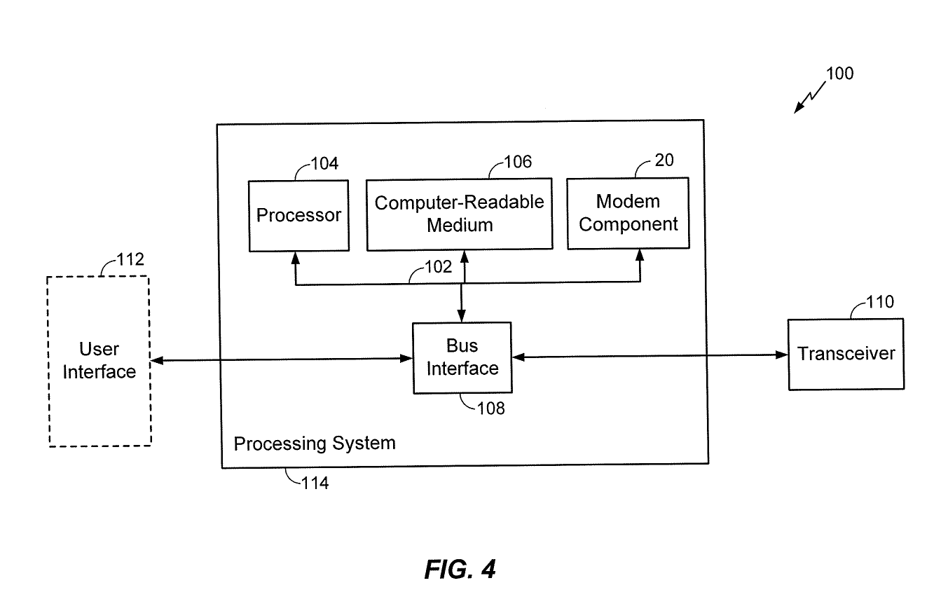

FIG. 4 is a block diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

The modem component 20 may be responsible for managing channels used by the apparatus 100. Various sub-components of the modem component 20 may be implemented as dedicated circuits connected to bus 102 or as software executed by processor 104. Moreover, the modem component 20 may include an internal receiver, transmitter, or transceiver or use transceiver 110. In another aspect, the modem component 20 may be implemented by software or firmware executed by processor 104.

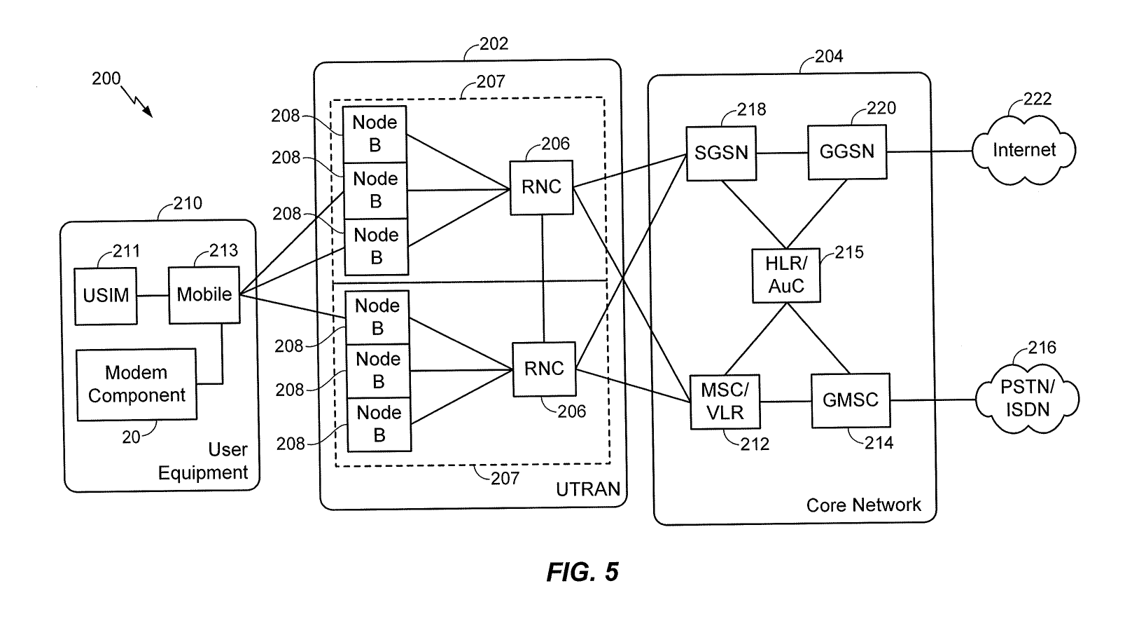

The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinless than utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. The UE 210 may further include mobile equipment 213 for managing connections to any of the multiple NodeBs 208. In some instances, modem component 20 may be implemented by or be resident within the mobile equipment 213. More generally, the modem component 20 may be implemented by or be resident within the UE 210. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208. UE 210 may correspond to the UE 12 illustrated in FIG. 1. The modem component 20 (FIG. 1) may be responsible for managing channels used by the UE 210 for communication with multiple Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

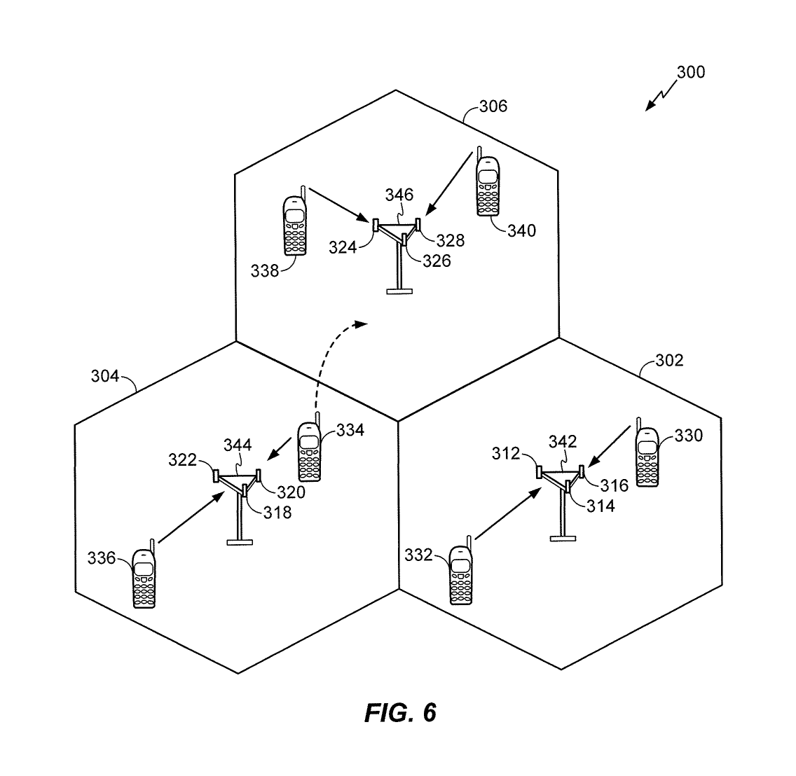

Referring to FIG. 6, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 2) for all the UEs 330, 332, 334, 336, 338, 340 in the respective cells 302, 304, and 306. The UEs 330, 332, 334, 336, 338, 340 may each be an example of a UE 12 (see FIG. 1) and may include the modem component 20.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 5), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set). A UE 334 may manage the channels in the active set as described infra. In particular, the UE 334 may remove a spurious DPCH that is contributing negatively to signal quality. UE 334 may further use event reporting to manage the Active Set to exclude a cell that is providing a spurious DPCH.

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

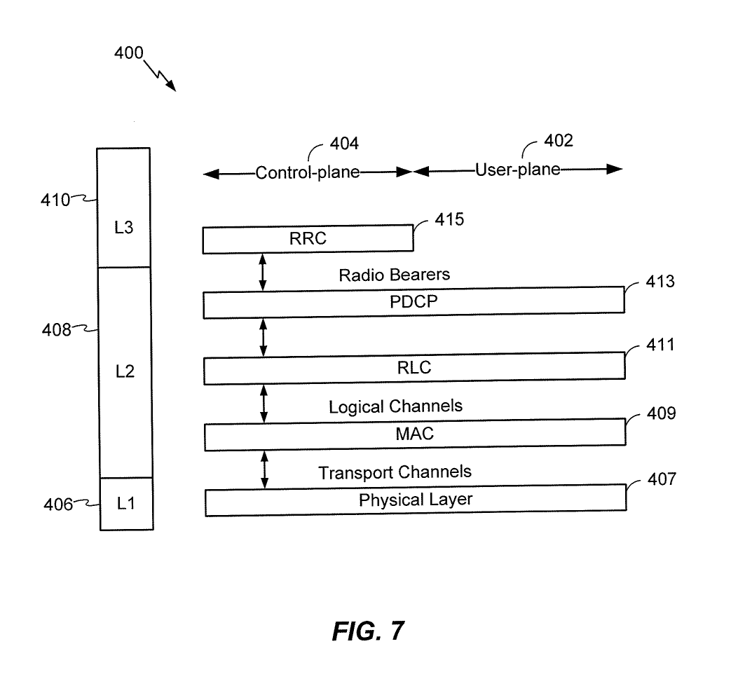

The radio protocol architecture may take on various forms depending on the particular application. An example for an HSPA system will now be presented with reference to FIG. 7.

Referring to FIG. 7 an example radio protocol architecture 400 relates to the user plane 402 and the control plane 404 of a user equipment (UE) or node B/base station. For example, architecture 400 may be included in a UE such as wireless device 12 (FIG. 1). The radio protocol architecture 400 for the UE and node B is shown with three layers: Layer 1 406, Layer 2 408, and Layer 3 410. Layer 1 406 is the lowest lower and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

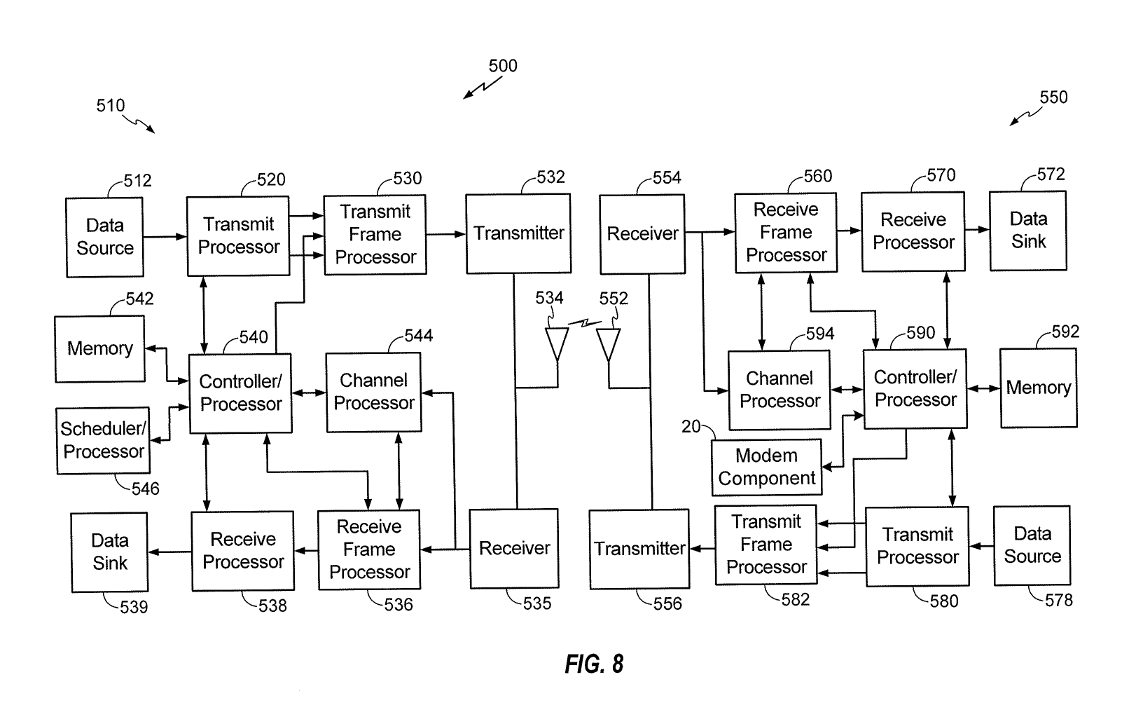

FIG. 8 is a block diagram of a Node B 510 in communication with a UE 550, where the Node B 510 may be the Node B 208 in FIG. 5 or the network entity 14 in FIG. 1, and the UE 550 may be the UE 210 in FIG. 5 or the UE 12 in FIG. 1. The UE 550 may include the modem component 20 that is configured or operable for handling spurious DPCHs. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

UE 510 may further include a modem component 20 as discussed infra regarding FIG. 1. The modem component 20 may be responsible for managing channels used by the UE 510. Various sub-components of the modem component 20 may be implemented by the components of UE 510. For example, the channel processor 594 may implement various aspects of the analyzer 30. The controller 590 may implement various aspects of the channel controller 40.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
determining that a dedicated physical channel (DPCH) is spurious;
removing the DPCH from soft combining; and
sending a report indicating that a cell associated with the DPCH is unavailable.

2. The method of claim 1, further comprising:
incrementing a counter for the cell associated with the DPCH in response to removing the DPCH;
determining whether the counter exceeds a removal threshold; and
increasing a time to trigger for sending a report to add the cell to an active set in response to the counter exceeding the removal threshold.

3. The method of claim 2, further comprising removing the cell from measurements of a current frequency.

4. The method of claim 1, wherein determining that the DPCH is spurious comprises determining that a quality measurement of a common pilot channel (CPICH) of the cell is greater than a quality threshold and a quality measurement of the DPCH for the cell is less than a quality threshold.

5. The method of claim 1, wherein determining that the DPCH is spurious comprises determining a ratio of a quality measurement of a common pilot channel (CPICH) of the cell to a quality measurement of the DPCH of the cell.

6. The method of claim 1, wherein determining that the DPCH is spurious comprises determining that a quality measurement of the DPCH for the cell is less than the quality measurement of a DPCH for a plurality of other cells in an active set.

7. The method of claim 1, wherein determining that a DPCH is spurious comprises determining that the DPCH contributes negatively to soft combining.

8. The method of claim 1, further comprising receiving an active set update command indicating that a cell corresponding to the spurious DPCH has been removed from an active set in response to the report.

9. The method of claim 1, wherein sending the report indicating that a cell associated with the DPCH is unavailable occurs despite receiving a CPICH for the cell satisfying a quality threshold.

10. An apparatus for wireless communication, comprising:
means for determining that a dedicated physical channel (DPCH) is spurious;
means for removing the DPCH from soft combining; and
means for sending a report indicating that a cell associated with the DPCH is unavailable.

11. The apparatus of claim 10, further comprising:
means for incrementing a counter for the cell associated with the DPCH in response to removing the DPCH;
means determining whether the counter exceeds a removal threshold; and
means increasing a time to trigger for sending a report to add the cell to an active set in response to the counter exceeding the removal threshold.

12. The apparatus of claim 11, further comprising means for removing the cell from measurements of a current frequency.

13. The apparatus of claim 10, wherein determining that the DPCH is spurious comprises determining that a common pilot channel (CPICH) of a cell is greater than a quality threshold and the DPCH for the cell is less than a quality threshold.

14. The apparatus of claim 10, wherein determining that the DPCH is spurious comprises determining that a quality measurement of the DPCH for the cell is less than the quality measurement of a DPCH for a plurality of other cells in an active set.

15. The apparatus of claim 10, wherein determining that the DPCH is spurious comprises determining that the DPCH contributes negatively to signal strength.

16. The apparatus of claim 10, further comprising receiving an active set update command indicating that the cell corresponding to the spurious DPCH has been removed from an active set in response to the report.

17. A computer program product, having a non-transitory computer-readable medium comprising:
code for causing a computer to determine that a dedicated physical channel (DPCH) is spurious;
code for causing the computer to remove the DPCH from soft combining; and
code for causing the computer to send a report indicating that a cell associated with the DPCH is unavailable.

18. The computer program product of claim 17, further comprising:
code for causing the computer to increment a counter for the cell associated with the DPCH in response to removing the DPCH;
code for causing the computer to determine whether the counter exceeds a removal threshold; and
code for causing the computer to increase a time to trigger for sending a report to add the DPCH to an active set in response to the counter exceeding the removal threshold.

19. The computer program product of claim 18, further comprising code for causing the computer to remove the cell from measurements of a current frequency.

20. The computer program product of claim 17, wherein the code for causing the computer to determine that a DPCH is spurious comprises code for causing the computer to determine that a common pilot channel (CPICH) of a cell is greater than a quality threshold and the DPCH for the cell is less than a quality threshold.

21. The computer program product of claim 17, wherein the code for causing the computer to determine that a DPCH is spurious comprises code for causing the computer to determine that a quality measurement of the DPCH for a cell is less than the quality measurement of a DPCH for a plurality of other cells in an active set.

22. An apparatus for wireless communication, comprising:
at least one processor; and
a memory coupled to the at least one processor,
wherein the at least one processor is configured to:
determine that a dedicated physical channel (DPCH) is spurious;
remove the DPCH from soft combining; and
send a report indicating that a cell associated with the DPCH is unavailable.

23. The apparatus of claim 22, wherein the at least one processor is further configured to:
increment a counter for the cell associated with the DPCH in response to removing the DPCH;
determine whether the counter exceeds a removal threshold; and
increase a time to trigger for sending a report to add the cell to an active set in response to the counter exceeding the removal threshold.

24. The apparatus of claim 23, further comprising removing the cell from measurements for a current frequency.

25. The apparatus of claim 22, wherein determining that the DPCH is spurious comprises determining that a quality measurement of a common pilot channel (CPICH) of the cell is greater than a quality threshold and a quality measurement for the DPCH for the cell is less than a quality threshold.

26. The apparatus of claim 24, wherein the processor is configured to determine that the DPCH is spurious based on a ratio of a quality measurement of a common pilot channel (CPICH) of the cell to a quality measurement of the DPCH of the cell.

27. The apparatus of claim 22, wherein determining that the DPCH is spurious comprises determining that a quality of the DPCH for the cell is less than the quality of a DPCH for a plurality of other cells in an active set.

28. The apparatus of claim 22, wherein determining that the DPCH is spurious comprises determining that the DPCH contributes negatively to soft combining.

29. The apparatus of claim 22, wherein the processor is configured to send the report indicating that a cell associated with the DPCH is unavailable despite the CPICH for the cell satisfying a quality threshold.

30. The apparatus of claim 22, wherein the processor is further configured to receive an active set update command indicating that the cell corresponding to the spurious DPCH has been removed from an active set in response to the report.
